(19) United States
(12) Patent Application Publication
(10) Pub. No.: US 2007/0147592 A1
(43) Pub. Date: Jun. 28, 2007

(54) Telephone and program

(75) Inventors: Tomonori Ikumi, Shizuoka (JP); Tomonari Kakino, Shizuoka (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: TOSHIBA TEC KABUSHIKI KAISHA, Tokyo (JP)

(21) Appl. No.: 10/555,294

(22) PCT Filed: May 30, 2005
(86) PCT No.: PCT/JP05/09866

§ 371 Date: Feb. 9, 2007

(30) Foreign Application Priority Data
May 28, 2004 (JP) 2004-159572

(51) Int. Cl. H04M 1/64

(52) U.S. Cl. 379/88.02

(57) ABSTRACT

To protect an elderly person living alone or the like from a crime such as “a confidence game”, a personality feature indicative of personality is extracted from a voice signal of a person required to be preliminarily registered and stored into a storage. When a call is received, a personality feature indicative of personality is extracted from a voice signal from a telephone line and compared with the personality feature stored in the storage to determine whether or not the caller of the voice signal input from the telephone line is any of persons whose personal features are registered in the storage, and notifies of the result of determination. Consequently, when there is a call from an unregistered person whose personal feature is not stored in the storage, the fact is notified.

### TECHNICAL FIELD

The present invention relates to a telephone and a program.

### Background Art

Hitherto, as an application of a speaker recognizing technique, a telephone answer assisting apparatus/method as described in Patent Document 1 has been proposed. According to the telephone answer assisting apparatus/method of Patent Document 1, to enable the other party of a call to be easily specified in a telephone answering work in a company or organization, a caller is identified from voice data received, contents of the voice data is recognized, and the other party is determined on the basis of the information. To identify a caller from voice data in the telephone answer assisting apparatus/method of Patent Document 1, a speaker recognizing technique of a “text-dependent type” of performing identification on specific words as objects is used.

Patent Document 1: Japanese Patent Laid-Open No. 2003-158579

### DISCLOSURE OF INVENTION

In recent years, a so-called “confidence game” is often played in such a manner that a cheater makes a telephone call to an elderly person living alone while pretending his/her next of kin and cheats the elderly person of money as an out-of-court settlement of a traffic accident caused by the next of kin. Factors of the success of such a “confidence game” are that the cheater does not give his/her name and a victim enters a situation in which the victim cannot calmly judge if the caller is really a next of kin, like the case where the victim is in an unordinary situation that his next of kin causes a traffic accident, so that an elderly person is confused that the other party is the next of kin of himself/herself.

It can be therefore considered to identify a caller from received voice data, recognize the voice data, and determine the other party on the basis of the information by using the telephone answer assisting method of Patent Document 1.

However, in a scene such as a “confidence game”, a malicious caller does not always utter predetermined words. It is therefore necessary to perform a “text independent type” speaker recognition of making identification during free conversation without designating words. Generally, the “text independent type” requires a calculation amount much larger than that of the “text dependent type”. Particularly, in the case where there are a plurality of registered persons, it is difficult to perform “speaker authentication” on all of the registered persons.

An object of the present invention is to provide a telephone and a program capable of preventing an elderly person living alone and the like from becoming a victim of a “confidence game” or the like.

The present invention provides a telephone connected to a telephone line, comprising: registration voice input means that receives an input of voice of a person requested to be preliminarily registered; first feature extracting means that extracts a personality feature indicative of personality from a voice signal received by the registration voice input means; storing means that stores the personality feature extracted by the feature extracting means into a storage; telephone voice input means that receives an input of voice from the telephone line; second feature extracting means that extracts a personality feature indicative of personality from a voice signal received by the telephone voice input means; determining means that compares the personality feature extracted by the second feature extracting means with the personal feature stored in the storage and determines whether a caller of the voice signal input from the telephone line is a person whose personality feature is registered in the storage or not; and determination result notifying means that notifies of a result of determination made by the determining means.

According to another aspect of the present invention, there is provided a telephone connected to a telephone line, comprising: registration voice input means that receives an input of voice of a person requested to be preliminarily registered; first feature extracting means that extracts a personality feature indicative of personality from a voice signal received by the registration voice input means; storing means that stores the personality feature extracted by the feature extracting means into a storage; telephone voice input means that receives an input of voice from the telephone line; second feature extracting means that extracts a personality feature indicative of personality from a voice signal received by the telephone voice input means; registered person selecting means that selects at least one of persons whose personality features are registered in the storage by the storing means; determining means that compares the personal feature registered in the storage, of a registered person selected by the registered person selecting means with the personality feature extracted by the second feature extracting means and determines whether a caller of the voice signal input from the telephone line is a person whose personality feature is registered in the storage or not; and determination result notifying means that notifies of a result of determination made by the determining means.

According to further another aspect of the invention, there is provided a program which can be read by a computer controlling a telephone connected to a telephone line, wherein the program makes the computer execute: a registration voice input function of receiving an input of voice of a person requested to be preliminarily registered; a first feature extracting function of extracting a personality feature indicative of personality from a voice signal received by the registration voice input function; a storing function of storing the personality feature extracted by the feature extracting function into a storage; a telephone voice input function of receiving an input of voice from the telephone line; a second feature extracting function of extracting a personality feature indicative of personality from a voice signal received by the telephone voice input function; a determining function of comparing the personality feature extracted by the second feature extracting function with the personal feature stored in the storage and determining whether a caller of the voice signal input from the telephone line is a person whose personality feature is registered in the storage or not; and a determination result notifying function of notifying of a result of determination made by the determining function.

### BRIEF DESCRIPTION OF DRAWINGS

FIG. 1 is a plane view showing a telephone of a first embodiment of the invention.

FIG. 2 is a block diagram showing the configuration of the telephone.

FIG. 3 is a functional block diagram showing the functions of the telephone.

FIG. 4 is a flowchart showing the flow of a caller identifying process.

FIG. 5 is a block diagram showing the configuration of a telephone of a second embodiment of the invention.

### PREFERRED EMBODIMENT FOR CARRYING OUT THE INVENTION

### First Embodiment

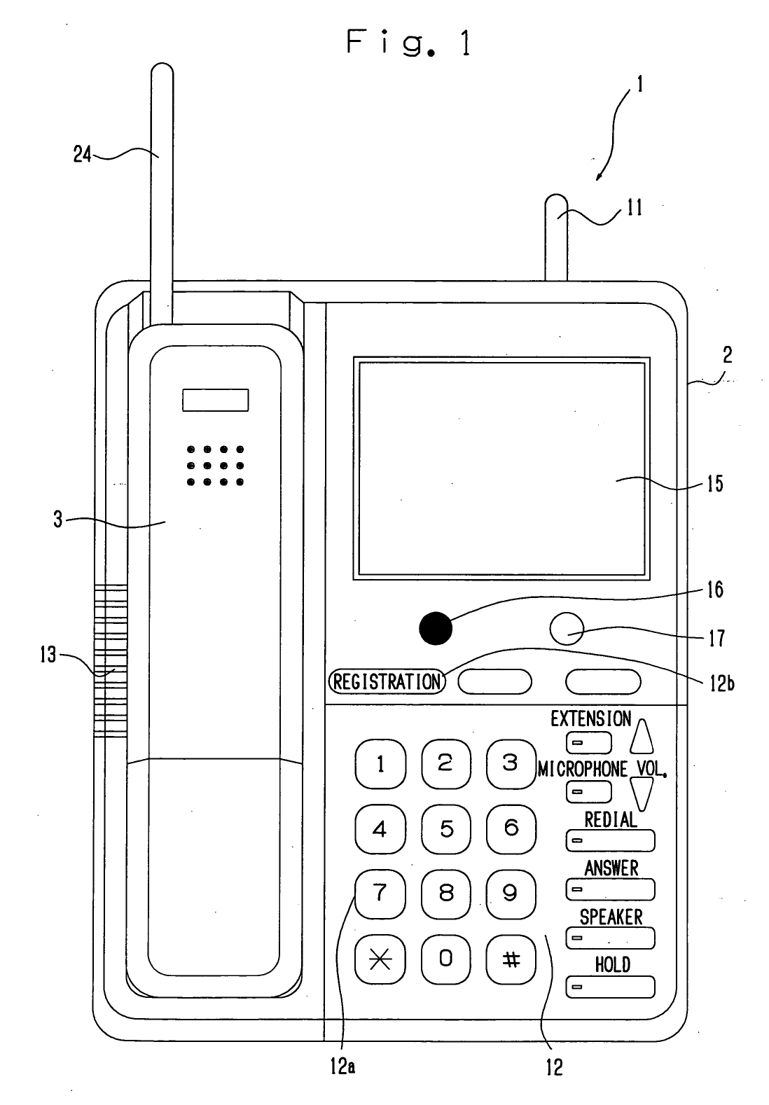

A first embodiment of the present invention will be described with reference to FIGS. 1 to 4. As a telephone of the first embodiment, a cordless telephone is applied.

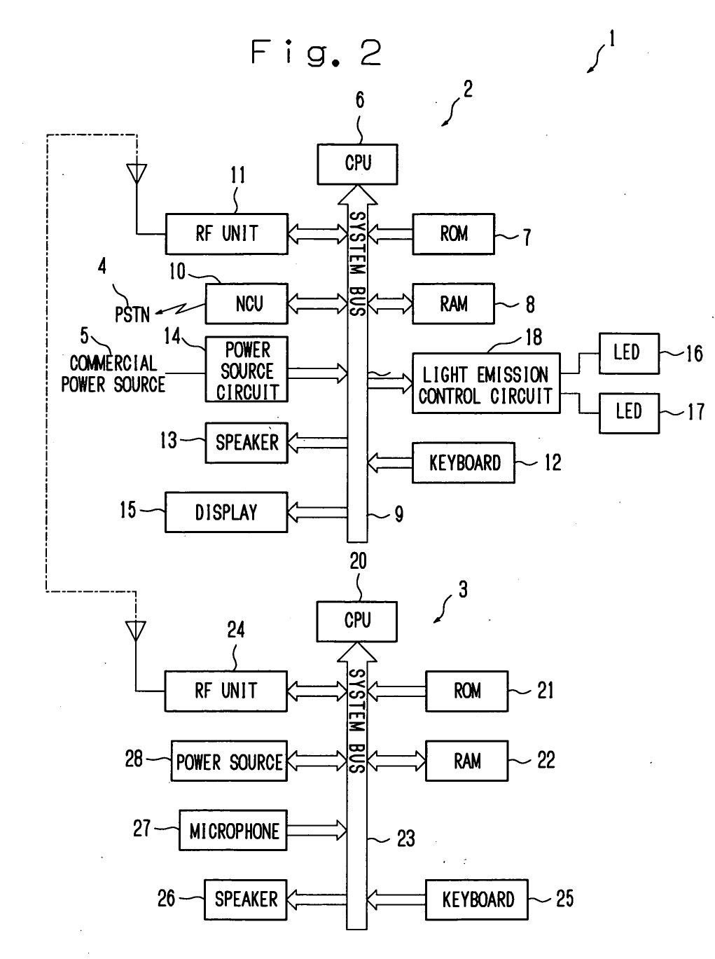

FIG. 1 is a plan view showing a telephone 1, and FIG. 2 is a block diagram showing the configuration of the telephone 1. As shown in FIGS. 1 and 2, the telephone 1 of the first embodiment has a structure in which a base 2 connected to a PSTN (Public Switched Telephone Network) 4 and a commercial power source 5, and a handset 3 performing wireless communication with the base 2 are provided independently of each other.

The base 2 has a CPU (Central Processing Unit) 6 for controlling the components. To the CPU 6, a ROM (Read Only Memory) 7 as a storage medium on which fixed data such as a control program to be executed by the CPU 6 is written and a RAM (Random Access Memory) 8 on which variable data such as work data is updatably written are connected via a system bus 9. To the CPU 6, an NCU (Network Control Unit) 10 connected to the PSTN 4, an RF (Radio-Frequency) unit 11 as wireless means for the handset 3, a keyboard 12, a speaker 13 as voice generating means, a power source circuit 14, and a display 15 are connected via the system bus 9. The keyboard 12 has an external structure in which numeric keys 12a from “0” to “9” for entering a number, a registration mode setting button 12b for setting an operation mode of the telephone 1 as a registration mode by a registering person such as the user or a next of kin of the user, and the like are arranged.

In addition, two LEDs 16 and 17 as light emitting means are arranged in the base 2 of the telephone 1 of the embodiment, and a light emission control circuit 18 for controlling light emission of the LEDs 16 and 17 is also connected to the CPU 6 via the system bus 9. The LED 16 emits blue light and the LED 17 emits red light.

On the other hand, the handset 3 also has a CPU 20 for controlling components. To the CPU 20, a ROM 21 and a RAM 22 are connected via s system bus 23. To the CPU 20, an RF unit 24 as wireless means for the base 2, a keyboard 25, a speaker 26, a microphone 27 functioning as a voice input unit, and a rechargeable power source 28 are connected via the system bus 23.

Next, an advantageous process of the embodiment in various computing processes executed by the CPU 6 in accordance with the control program stored in the ROM 7 provided in the base 2 of the telephone 1 will be described hereinbelow.

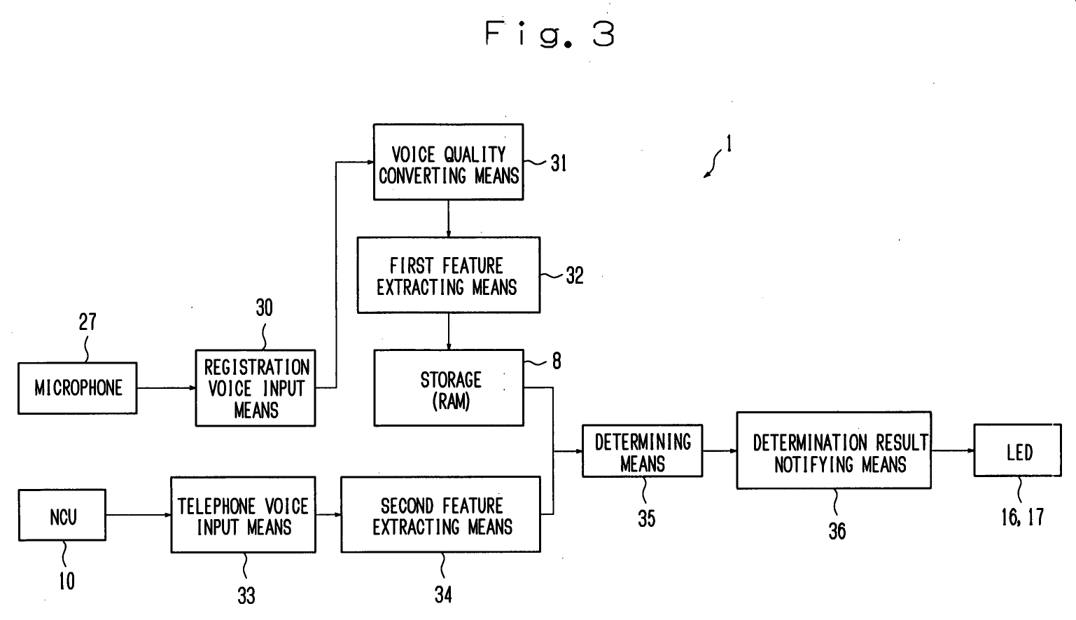

The functions realized by the various computing processes executed by the CPU 6 provided in the base 2 of the telephone 1 will be described. As shown in FIG. 3, in the telephone 1, functions of a registration voice input means 30, a voice quality converting means 31, a first feature extracting means 32, a telephone voice input means 33, a second feature extracting means 34, a determining means 35, and a determination result notifying means 36 are realized by the various computing processes executed by the CPU 6. In the case where importance is placed on real-time performance, it is necessary to perform the processes at higher speed. For this purpose, it is desirable to separately provide a logic circuit (not shown) and realize the various functions by the operation of the logic circuit.

The registration voice input means 30 receives an input of voice from the microphone 27 of the handset 3.

The voice quality converting means 31 converts the voice received by the registration voice input means 30 into telephone voice quality (4 kHz and 8 bits in the case of a general telephone line). The voice quality converting means 31 outputs the registration voice converted to the telephone voice quality to the first feature extracting means 32. The voice input from the microphone 27 of the handset 3 is converted to the telephone voice quality by the voice quality converting means 31 as described above for the reason that when the qualities of source signals are equivalent, whether the caller is a registered person or not can be determined more accurately. When the performance of the microphone 27 is low or when it is expected that variations of voice qualities can be absorbed by the first feature extracting means 32, the voice quality converting means 31 may not be provided.

When the registration voice converted to the telephone voice quality is received, the first feature extracting means 32 extracts a personality feature such as a cepstrum coefficient having personality, and stores the extracted personality feature into the RAM 8 as a storage. By the above operation, the procedure of registering the caller is completed.

When a telephone call is received by the telephone 1, the telephone voice input means 33 receives the voice of the caller via the NCU 10.

The second feature extracting means 34 extracts a personality feature such as a cepstrum coefficient having personality from the voice of the caller received by the telephone voice input means 33.

The determining means 35 compares the feature stored in the RAM 8 as a storage with the feature of the caller newly extracted to determine whether the voice of the caller is that of the registered person or not, and outputs the result of determination to the determination result notifying means 36.

The determination result notifying means 36 makes one of the two LEDs 16 and 17 emit light in accordance with the result of determination made by the determining means 35. For example, it is set so that when the caller is determined as a registered person, the blue LED 16 emits light and, when the caller is not a registered person, the red LED 17 emits light. When such a setting is made and a next of kin of the user teaches the user not to trust a caller when the red LED 17 emits light because the caller is someone the user does not know, the user can be prevented from becoming the victim of a crime such as “a confidence game”.

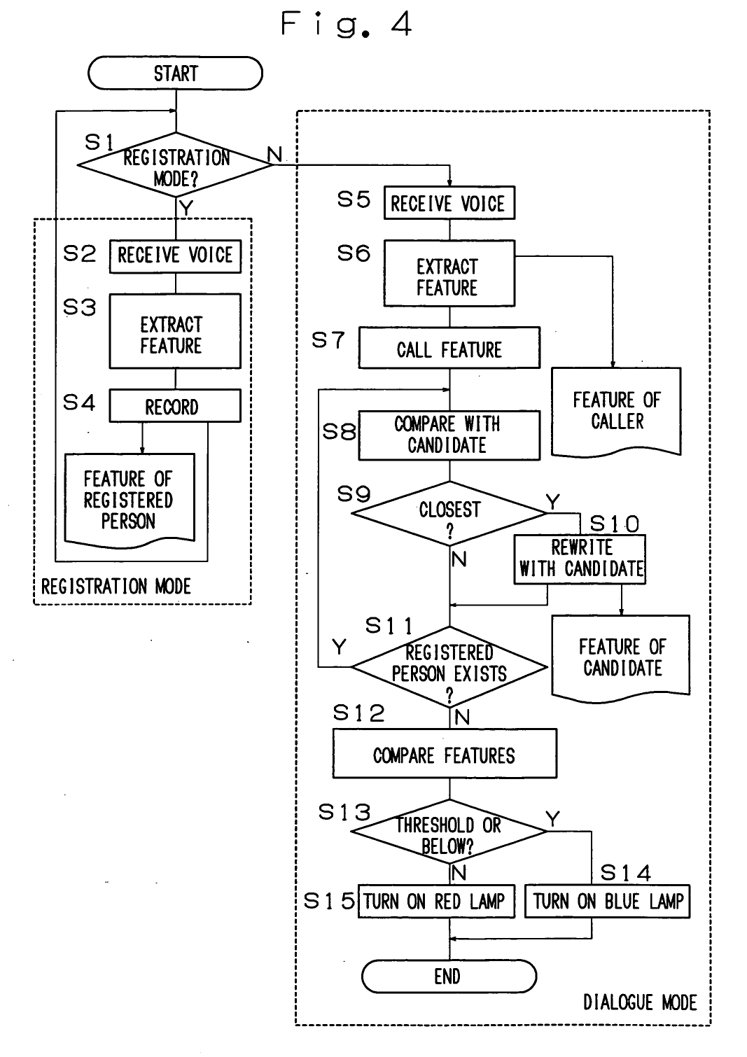

The flow of a caller identifying process performed by the registration voice input means 30, voice quality converting means 31, first feature extracting means 32, telephone voice input means 33, second feature extracting means 34, determining means 35, and determination result notifying means 36 as described above will be described in detail with reference to the flowchart of FIG. 4.

As shown in FIG. 4, in step S1, whether the operation mode of the telephone 1 is the registration mode or not is determined. The mode determination is designated by, for example, an operation on the registration mode setting button 12b of the keyboard 12 by a registering person such as the user, a next of kin of the user, or the like. By detecting whether the registration mode setting button 12b is operated or not, the registration mode or a normal dialog mode is determined.

In the case where the operation mode of the telephone 1 is determined as the registration mode (Y in step S1), when voice input from the microphone 27 of the handset 3 is received, the voice is converted to telephone voice quality (4 KHz and 8 bits in the case of a general telephone line) (step S2).

After that, a personality feature such as a cepstrum coefficient having personality is extracted from the registered voice converted to the telephone voice quality (step S3), and the extracted personal feature (registered person feature) is stored in the RAM 8 as a storage (step S4). By the above, the procedure of registering the caller is completed. In the embodiment, a case is imagined where an elderly person who lives alone uses the telephone 1 and someone like a next of kin of the elderly person directly makes a setting on the telephone 1 so that the next of kin of the elderly person is registered.

In the case of performing the procedure of registering a plurality of callers, it is sufficient to repeat the processes in steps S2 to S4.

On the other hand, in the case where the operation mode of the telephone 1 is determined as the normal dialog mode (N in step S1), when a call is received by the telephone 1 and voice of the caller is received via the NCU 10 (step S5), the personality feature (caller feature) such as a cepstrum coefficient having personality is extracted (step S6).

Subsequently, the registered person features preliminarily registered in the registration mode are called from the RAM 8 (step S7), and the called registered person features are sequentially compared with the caller feature extracted in step S6 (step S8). When it is determined as a result of comparison between the called one registered person feature and the caller feature extracted in step S6 that the called one registered person feature is the closest to the caller feature extracted in step S6 (Y in step S9), the registered person feature is temporarily stored as a candidate feature in the RAM 8 (step S10). In the case where a candidate feature is already stored in the RAM 8, it is rewritten with the new candidate feature. The processes in steps S8 to S10 are repeated until the comparison between all of registered person features and the caller feature extracted in step S6 is finished (Y in step S11).

When a candidate closest to the caller is selected in such a manner, the program advances to step S12 where the caller feature and the candidate feature are compared with each other. In the embodiment, whether the difference between the two features is larger or smaller than a preset threshold is determined.

When the difference between the two features is equal to or smaller than the preset threshold (Y in step S13), it is determined that the caller is the registered person, and the blue LED 16 is allowed to emit light (step S14). On the other hand, when the difference between the two features is larger than the preset threshold (N in step S13), it is determined that the caller is not the registered person, and the red LED 17 is allowed to emit light (step S15).

In such a manner, when a call is received by the telephone 1, the user such as an elderly person living alone can make sure that the caller is the registered person such as a next of kin when the blue LED 16 emits light, and recognizes that the caller is not a registered person such as a next of kin when the red LED 17 emits light. Consequently, when the red LED 17 emits light during conversation with the other party who calls himself/herself one of the registered persons such as a next of kin, the user can be on alert for the lie.

According to the embodiment as described above, the personality feature indicative of personality is extracted from the voice signal of a person required to be preliminarily registered, which is input from the microphone 27 functioning as the voice input part, and stored in the RAM 8 as a storage. Meanwhile, when a call is received, the personality feature indicative of personality is extracted from the voice signal from the PSTN 4 as a telephone line and is compared with the personality feature stored in the RAM 8, thereby determining whether the caller of the voice signal input from the PSTN 4 as a telephone line is any of persons whose personality features are registered in the RAM 8 or not is determined. The result of determination is notified. In such a manner, in the case where a call is received by the telephone 1, if the call is from a person whose personality feature is not stored in the RAM 8, the user is notified of the fact. Consequently, when an elderly person living alone or the like uses the telephone 1 and registers a next of kin or the like, the elderly person can be protected from a crime such as “a confidence game”.

In the embodiment, by making one of the blue LED 16 and the red LED 17 emit light, whether the other party is a registered person or not is notified. However, the invention is not limited to the method. For example, an output of the result of determination can be also notified by using sound or the like. Concretely, it can be realized as follows. When the caller is determined as a registered person, voice of “It's registered person”, “It's Mr xxx (xxx is a person's name)”, or the like is output from the speaker 13 of the base 2 of the telephone 1. When the caller is determined as a person who is not registered, voice such as “It's a call from an unregistered person” is output from the speaker 13. When a call is determined as a call from an unregistered person, a warning such as “watch out” can be also sent. It is also effective not to output the result of determination when the caller is determined as a registered person so as not to disturb conversation and to output voice only when the caller is determined as an unregistered person. Further, it is also good to output the result of determination not from the speaker 13 of the base 2 of the telephone 1 but to output the result so as to interfere with voice input from the microphone 27 of the handset 3 or an output sound to the speaker 26. That is, a message such as “this is a call from an unregistered person” may be output so that the user and also the caller can hear it. In such a manner, the user can be warned that the call is from an unregistered person and the caller is made know that the telephone is with a caller recognizing function, that is, a telephone with a “cheating” preventing function.

In step S8 of the embodiment, the called registered person features are sequentially compared with the caller feature extracted in step S6. Alternately, a registered person selection key (not shown) which is set for each registered person whose personality feature is registered is prepared in the keyboard 12. For example, by operating a registered person selection key of a registered person such as a next of kin whose name is given by the caller, one of persons whose personality features are registered on the RAM 8 as a storage is selected (registered person selecting means), and the personality feature of the registered person selected by the operation on the registered person selection key is compared with the caller feature extracted in step S6. In such a manner, features can be promptly compared and the process can be lessened. By operating a plurality of registered person selection keys, two or more persons may be simultaneously selected.

### Second Embodiment

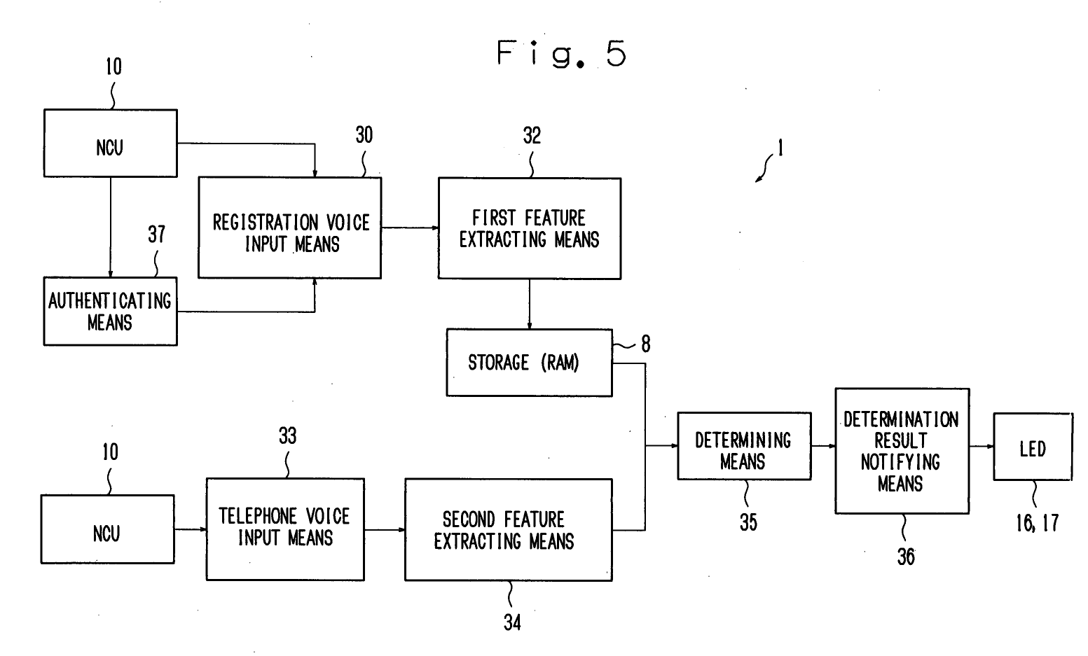

A second embodiment of the invention will now be described with reference to FIG. 5. The same parts as those of the first embodiment will be indicated by the same reference numerals and their description will not be repeated. The case of receiving voice from the microphone 27 of the handset 3 and directly setting the voice to the telephone 1 has been described in the first embodiment. The second embodiment is different from the first embodiment with respect to the point that voice is input via the PSTN 4 as a telephone line and a person to be registered is registered.

The function realized by the various computing processes executed by the CPU 6 provided in the base 2 of the telephone 1 of the embodiment will be described. As shown in FIG. 5, in the telephone 1, functions of an authenticating means 37, the registration voice input means 30, the first feature extracting means 32, the telephone voice input means 33, the second feature extracting means 34, the determining means 35, and the determination result notifying means 36 are realized by the various computing processes executed by the CPU 6. In the case where importance is placed on real-time performance, it is necessary to perform the processes at higher speed. For this purpose, it is desirable to separately provide a logic circuit (not shown) and realize the various functions by the operation of the logic circuit.

The authenticating means 37 performs authentication when a person to be registered tries to register his/her voice via the PSTN 4. The authentication can be realized by sending a personal identification number or the like at the DTMF (Dial Tone Multi Frequency). By sending the personal identification number or the like at the DTMF, persons to be registered can be limited to next of kin and the like of the user.

When a call is received by the telephone 1, the registration voice input means 30 receives voice of the caller via the NCU 10. Only when the voice is authenticated by the authenticating means 37, the voice received by the registration voice input means 30 is output to the first feature extracting means 32. In this case, voice of the caller is received via the NCU 10. Consequently, unlike the first embodiment, it is unnecessary to convert the received voice to telephone voice quality (4 kHz and 8 bits in the case of a general telephone line).

When the voice output from the registration sound input means 30 is received, the first feature extracting means 32 extracts, for example, a personality feature such as a cepstrum coefficient having personality, and stores the extracted personality feature into the RAM 8 as a storage. By the above operation, the procedure of registering the caller is completed.

When a telephone call is received by the telephone 1, the telephone voice input means 33 receives the voice of the caller via the NCU 10.

The second feature extracting means 34 extracts a personality feature such as a cepstrum coefficient having personality from the voice of the caller received by the telephone voice input means 33.

The determining means 35 compares the feature stored in the RAM 8 as a storage with the feature of the caller newly extracted to determine whether the voice of the caller is that of the registered person or not, and outputs the result of determination to the determination result notifying means 36.

The determination result notifying means 36 makes one of the two LEDs 16 and 17 emit light in accordance with the result of determination made by the determining means 35. For example, it is set so that when the caller is determined as a registered person, the blue LED 16 emits light and, when the caller is not a registered person, the red LED 17 emits light. When such a setting is made and a next of kin of the user teaches the user not to trust a caller when the red LED 17 emits light because the caller is someone the user does not know, the user can be prevented from becoming the victim of a crime such as “a confidence game”.

Alternately, when the telephone 1 is purchased and mounted, first, registration may be directly performed in a manner similar to the first embodiment and, after that, registration may be performed via the PSTN 4 in a manner similar to the second embodiment. It is known that characteristics of voice of a human being change with growth of the human being, changes in the body shape, a change in the body condition when the human being catches a cold, and the like. Usually, in the case of using the speaker recognizing technique, an operation of periodically updating registration or the like is performed to deal with a change in the voice quality. By performing the updating via the PSTN 4, the registered person does not have to come to the telephone 1 each time the updating is performed.

According to the second embodiment, the personality feature indicative of the personality is extracted from a voice signal of a person to be preliminarily registered, which is input via the PSTN 4 as a telephone line, and is stored in the RAM 8 as a storage. Meanwhile, when a call is received, the personality feature indicative of personality is extracted from the voice signal from the PSTN 4 as a telephone line and is compared with the personality feature stored in the RAM 8, thereby determining whether the caller of the voice signal input from the PSTN 4 as a telephone line is any of persons whose personality features are registered in the RAM 8 or not is determined. The result of determination is notified. In such a manner, in the case where a call is received by the telephone 1, if the call is from a person whose personality feature is not stored in the RAM 8, the user is notified of the fact. Consequently, when an elderly person living alone or the like uses the telephone 1 and registers a next of kin or the like, the elderly person can be protected from a crime such as “a confidence game”.

Although the ROM 7 is applied as a storage medium in each of the foregoing embodiments, not only the ROM 7 but also various media such as a semiconductor memory can be used. It is also possible to download a program via a network such as the Internet and install the program onto a nonvolatile ROM or the like. In this case, a storage on which the program is stored on a server on the transmission side is also the storing medium of the invention. As the program, a program which operates on a predetermined OS (Operating System) may be used. In this case, part of the various processes may be performed by the OS. The program may be included as part of a group of program files constructing predetermined application software, OS, or the like.

Although the cordless telephone 1 is used as the telephone in the foregoing embodiments, the telephone 1 is not limited to the cordless telephone but may be a cellular phone or the like.

Further, although the embodiments have been described that two feature extracting means are provided, which are the first feature extracting means for performing authentication upon registration and the second feature extracting means performing authentication when a call is actually received, the same feature extracting means may be used as the first and second feature extracting means.

1. A telephone connected to a telephone line, comprising:
registration voice input means that receives an input of voice of a person requested to be preliminarily registered;
first feature extracting means that extracts a personality feature indicative of personality from a voice signal received by the registration voice input means;
storing means that stores the personality feature extracted by the feature extracting means into a storage;
telephone voice input means that receives an input of voice from the telephone line;
second feature extracting means that extracts a personality feature indicative of personality from a voice signal received by the telephone voice input means;
determining means that compares the personality feature extracted by the second feature extracting means with the personal feature stored in the storage and determines whether a caller of the voice signal input from the telephone line is a person whose personality feature is registered in the storage or not; and
determination result notifying means that notifies of a result of determination made by the determining means.

2. A telephone according to claim 1, wherein the voice input means accepts a voice input for transmitting voice via the telephone line.

3. A telephone according to claim 1, wherein the voice input means accepts a voice input from the telephone line.

4. A telephone according to claim 1, further comprising voice quality converting means that converts the voice accepted by the registration voice input means into telephone voice quality.

5. A telephone according to claim 1, further comprising light emitting means of two colors,
wherein the determination result notifying means makes one of the light emitting means of two colors emit light in accordance with a result of determination made by the determining means.

6. A telephone according to claim 1, further comprising voice generating means,
wherein the determination result notifying means outputs a result of determination made by the determining means via the voice generating means.

7. A telephone according to claim 1, wherein the determination result notifying means outputs a result of determination made by the determining means so as to interfere voice which is input from a voice input part.

8. A telephone connected to a telephone line, comprising:
registration voice input means that receives an input of voice of a person requested to be preliminarily registered;
first feature extracting means that extracts a personality feature indicative of personality from a voice signal received by the registration voice input means;
storing means that stores the personality feature extracted by the feature extracting means into a storage;
telephone voice input means that receives an input of voice from the telephone line;
second feature extracting means that extracts a personality feature indicative of personality from a voice signal received by the telephone voice input means;
registered person selecting means that selects at least one of persons whose personality features are registered in the storage by the storing means;
determining means that compares the personal feature registered in the storage, of a registered person selected by the registered person selecting means with the personality feature extracted by the second feature extracting means and determines whether a caller of the voice signal input from the telephone line is a person whose personality feature is registered in the storage or not; and
determination result notifying means that notifies of a result of determination made by the determining means.

9. A telephone according to claim 8, further comprising authenticating means that authenticates a person required to be preliminarily registered,
wherein only when a person is authenticated by the authenticating means, the registration voice input means outputs received voice to the first feature extracting means.

10. A program which can be read by a computer controlling a telephone connected to a telephone line, wherein the program makes the computer execute:
a registration voice input function of receiving an input of voice of a person requested to be preliminarily registered;
a first feature extracting function of extracting a personality feature indicative of personality from a voice signal received by the registration voice input function;
a storing function of storing the personality feature extracted by the feature extracting function into a storage;
a telephone voice input function of receiving an input of voice from the telephone line;
a second feature extracting function of extracting a personality feature indicative of personality from a voice signal received by the telephone voice input function;
a determining function of comparing the personality feature extracted by the second feature extracting function with the personal feature stored in the storage and determining whether a caller of the voice signal input from the telephone line is a person whose personality feature is registered in the storage or not; and
a determination result notifying function of notifying of a result of determination made by the determining function.
